(19) United States
(12) Patent Application Publication
(10) Pub. No.: US 2014/0348343 A1
(43) Pub. Date: Nov. 27, 2014

(54) AUDIO DEVICE FOR SUPPRESSING NOISE

(71) Applicants: HON HAI PRECISION INDUSTRY CO., LTD, New Taipei (TW); HONG FU JIN PRECISION INDUSTRY (ShenZhen) CO., LTD ., Shenzhen (CN)

(72) Inventors: YA-GUO WANG, Shenzhen (CN); CHUN-CHING CHEN, New Taipei (TW)

(73) Assignees: HON HAI PRECISION INDUSTRY CO., LTD, New Taipei (TW); HONG FU JIN PRECISION INDUSTRY (ShenZhen) CO., LTD ., Shenzhen (CN)

(21) Appl. No.: 14/142,984

(22) Filed: Dec. 30, 2013

(30) Foreign Application Priority Data
May 23, 2013 (CN) 2013101945456

(51) Int. Cl. H04R 3/00

(52) U.S. Cl. CPC H04R 3/002
USPC 381/94.5

(57) ABSTRACT

An audio device is capable of switching between a first state and a second state. The audio device comprises a power supply, a delay module, a control module, a processor, and an audio-playing module. The power supply provides a working voltage when the audio device is in the second state. The delay module is connected between the power supply and the control module, and outputs a delay signal when the audio device switches between the first state and the second state. The control module for outputting a driving signal is prevented from outputting driving signal in response to the delay signal, and the processor is enabled in response to the delay signal.

### BACKGROUND

1. Technical Field

The present disclosure relates to an audio device for suppressing noise.

2. Description of Related Art

Audio devices, such as DVD players, may generate noise while switching between a power-on state and a power-off state.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an embodiment of an audio device.

FIG. 2 is a circuit diagram of an embodiment of the audio device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one.”

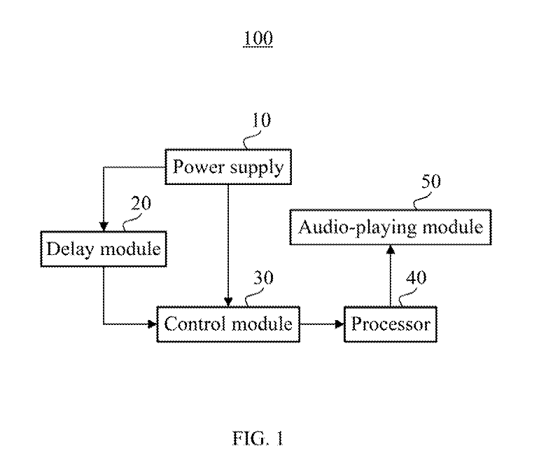

FIG. 1 shows an embodiment of an audio device 100. The audio device 100 is capable of preventing noise while switching between a first state and a second state. In one embodiment, the first state is a power-off state, and the second state is a power-on state. The audio device 100 can be, but is not limited to, a DVD player, a television, or a mobile phone.

In one embodiment, the audio device 100 includes a power supply 10, a delay module 20, a control module 30, a processor 40, and an audio-playing module 50.

The power supply 10 provides a working voltage to the delay module 20 and the control module 30 when the audio device 100 is in the second state.

The delay module 20 is electronically connected between the power supply 10 and the control module 30. The delay module 20 generates a delay signal to the control module 30 to enable the processor 40 when the audio device 100 switches between the first state and the second state. In one embodiment, the delay module 20 generates a delay signal in a first duration when the audio device 100 switches from the first state to the second state, and generates the delay signal in a second duration when the audio device switches from the second state to the first state. In one embodiment, the first duration is shorter than the second duration, and the delay signal is a logic-low signal.

The control module 30 is electronically connected between the power supply 10 and the processor 40. The control module 30 is prevented from outputting a driving signal by the delay signal, and resumes outputting the driving signal when the delay signal is not received. In one embodiment, the driving signal is a logic-low signal.

The processor 40 is electronically connected between the control module 30 and the audio-playing module 50. The processor 40 processes received audio signals, and transmits the processed audio signals to the audio-playing module 50 in response to the driving signal. The processor 40 stops processing the received audio signals when the driving signal is not received.

The audio-playing module 50 outputs the processed audio signals. In one embodiment, the audio-playing module 50 is a loud speaker. In other embodiments, the audio-playing module 50 is earphones.

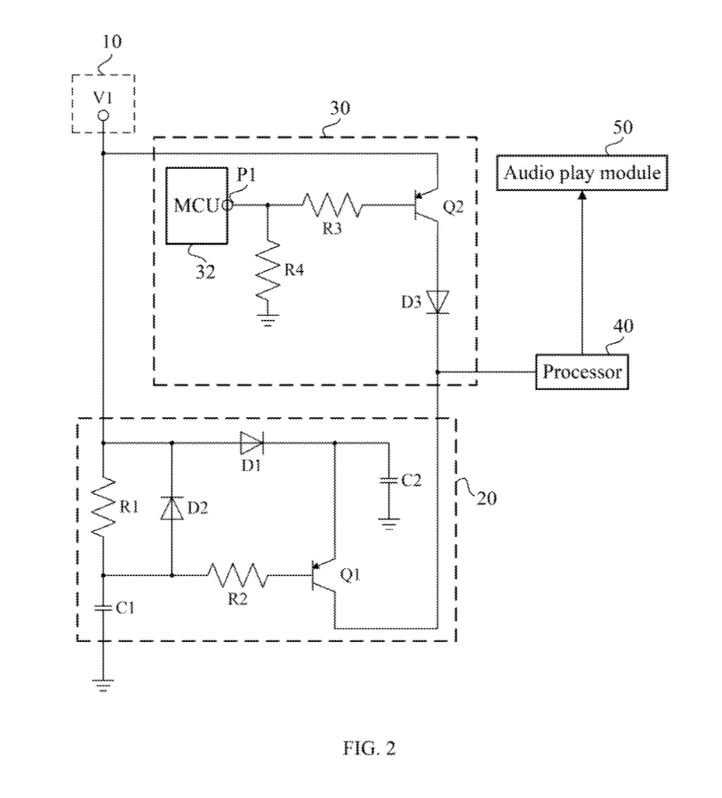

FIG. 2 shows that the power supply 10 includes a power source V1.

The delay module 20 includes a first transistor Q1, a first diode D1, a second diode D2, a first resistor R1, a second resistor R2, a first capacitor C1, and a second capacitor C2. A base of the first transistor Q1 is connected to the power source V1 through the second resistor R2 and the first resistor R1 in that order. An emitter of the first transistor Q1 is connected to the power source V1 through the first diode D1. A collector of the first transistor Q1 is connected to the control module 30. An anode of the first diode D1 is connected to the power source V1. A cathode of the first diode D1 is connected to the emitter of the first transistor Q1. An anode of the second diode D2 is connected between the first resistor R1 and the second resistor R2. A cathode of the second diode D2 is connected to the anode of the first diode D1. A terminal of the first capacitor C1 is connected between the first resistor R1 and the second resistor R2. Another terminal of the first capacitor C1 is grounded. A terminal of the second capacitor C2 is connected to the emitter of the first transistor Q1. Another terminal of the first capacitor C2 is grounded. In one embodiment, the first transistor Q1 is a pnp-type bipolar junction transistor. The first capacitor C1 and the second capacitor C2 are electrolytic capacitor, and the capacitance of the first capacitor C1 is larger than that of the second capacitor C2. In one embodiment, the first duration is a time of fully charging the first capacitor C1 and the second capacitor C2, and the second duration is a time for fully discharging the first capacitor C1 and the second capacitor C2.

The control module 30 includes a micro control unit (MCU) 32, a second transistor Q2, a third diode D3, a third resistor R3, and a fourth resistor R4. The MCU 32 includes a first pin P1. A base of the second transistor Q2 is connected to the first pin P1 through the third resistor R3. An emitter of the second transistor Q2 is connected to the power source V1. A collector of the second transistor Q2 is connected to the collector of the first transistor Q1 through the third diode D3. An anode of the third diode D3 is connected to the collector of the second transistor Q2. A cathode of the third diode D3 is connected to the collector of the first transistor Q1. A terminal of the fourth resistor R4 is connected to the first pin P1. Another terminal of the fourth resistor R4 is grounded. In one embodiment, the second transistor Q2 is a pnp-type bipolar junction transistor.

A working method of the audio device 100 is described as follow. When the audio device 100 switches from the first state to the second state, the first pin P1 outputs the logic-low signal, which cause a voltage difference between the emitter and the base of the second transistor Q2 to be more than 0.7 V, the second transistor Q2 is turned on and outputs the driving signal. At the same time, the power source outputs the working voltage, the voltage difference between the anode and the cathode of the first diode D1 is more than 0.3 volt (V), the first diode D1 turns on, a voltage of the emitter of the first transistor Q2 is equal to the working voltage. The first capacitor C1 and the second capacitor C2 are charged by the working voltage of the power source V1. Because of the difference in capacitance between the first capacitor C1 and the second capacitor C2, the voltage difference between the emitter and the base of the first transistor Q1 is more than 0.7 V, and the first transistor Q1 is turned on and generates the delay signal for disabling the processor 40.

When the first capacitor C1 is completely charged after the first duration, the voltage difference between the emitter and the base of the first transistor Q1 is less than 0.7 V, so the first transistor Q1 is turned off, and the delay module 20 stops generating the delay signal, and the driving signal is supplied to the processor 40, which cause the processor 40 to process the received audio signals and transmit the processed audio signals to the audio-playing module 50. The audio-playing module 50 outputs the processed audio signal.

When the audio device 100 switches from the second state to the first state, the first capacitor C1 and the second capacitor C2 begin discharging. Because the difference in capacitance between the first capacitor C1 and the second capacitor C2, the first capacitor C1 discharges faster than the second capacitor C2, the voltage difference between the anode and the cathode of the second diode D2 is more than 0.3 V, and the second diode D2 is turned on, which cause the voltage difference between the emitter and the base of the first transistor Q1 to increase to more than 0.7 V, and the first transistor Q1 is turned on, and generates the delay signal for immediately disabling the processor 40.

In summary, the audio device 100 is prevented from generating noise from switching between the first state and the second state and vice versa.

It is to be understood, however, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An audio device capable of switching between a first state and a second state, the audio device comprising:
a power supply for providing a working voltage when the audio device is in the second state;
a control module for outputting a driving signal when the audio device is in the second state
a delay module connected between the power supply and the control module, and for outputting a delay signal when the audio device switches between the first state and the second state;
a processor for processing audio signals based on the driving signal; and
an audio-playing module for outputting the processed audio signal;
wherein the control module is prevented from outputting driving signal in response to the delay signal, and the processor is disabled in response to the delay signal.

2. The audio device of claim 1, wherein when the audio device switches from the first state to the second state, the delay module outputs the delay signal for a first duration, the control module firstly stops outputting driving signal in response to the delay signal for disabling the processor and resumes to output the driving signal after the first duration.

3. The audio device of claim 2, wherein when the audio device switches from the second state to the first state, the delay module outputs the delay signal for a second duration, the control module stops outputting driving signal in response to the delay signal immediately.

4. The audio device of claim 3, wherein the first duration is shorter than the second duration.

5. The audio device of claim 1, wherein the delay module comprises a first transistor, a first diode, a second diode, a first resistor, a first capacitor, and a second capacitor; a base of the first transistor is connected to the power supply through the first resistor; an emitter of the first transistor is connected to the power supply through the first diode; a collector of the first transistor is connected to the control module; an anode of the first diode is connected to the power supply; a cathode of the first diode is connected to the emitter of the first transistor; an anode of the second diode is connected to the power supply through the first resistor; a cathode of the second diode is connected to the anode of the first diode; a terminal of the first capacitor is connected power supply through the first resistor; another terminal of the first capacitor is grounded; a terminal of the second capacitor is connected to the emitter of the first transistor; another terminal of the first capacitor is grounded.

6. The audio device of claim 5, wherein the first capacitor and the second capacitor are electrolytic capacitor, and the capacitance of the first capacitor is larger than that of the second capacitor.

7. The audio device of claim 1, wherein the control module comprises a micro control unit (MCU), a second transistor, a third diode; the MCU comprises a first pin; a base of the second transistor is connected to the first pin; an emitter of the second transistor is connected to the power supply; a collector of the second transistor is connected to the delay module through the third diode; an anode of the third diode is connected to the collector of the second transistor; a cathode of the third diode is connected to the delay module.

8. The audio device of claim 1, wherein the driving signal is a logic-low signal, and the delay signal is a logic-high signal.

9. An audio device capable of switching between a first state and a second state, the audio device comprising:
a power supply for providing a working voltage when the audio device is in the second state;
a control module for outputting a driving signal based on the working voltage when the audio device is in the second state
a delay module connected between the power supply and the control module;
a processor connected to the control module, and for processing audio signals based on the driving signal; and
an audio-playing module for outputting the processed audio signal;
wherein when the audio device switches from the first state to the second state, the delay module is being charged for a first duration based on the working voltage and controls the control module to stop driving the processor, and the processor is disabled; when after the first duration, the delay module is being completely charged and controls the control module to drive the processor, the processor is enabled.

10. The audio device of claim 9, wherein when the audio device switches from the second state to the first state, the delay module is being discharged for a second duration and controls the control module to stop driving the processor immediately.

11. The audio device of claim 10, wherein the first duration is shorter than the second duration.

12. The audio device of claim 9, wherein the delay module comprises a first transistor, a first diode, a second diode, a first resistor, a first capacitor, and a second capacitor; a base of the first transistor is connected to the power supply through the first resistor; an emitter of the first transistor is connected to the power supply through the first diode; a collector of the first transistor is connected to the control module; an anode of the first diode is connected to the power supply; a cathode of the first diode is connected to the emitter of the first transistor; an anode of the second diode is connected to the power supply through the first resistor; a cathode of the second diode is connected to the anode of the first diode; a terminal of the first capacitor is connected power supply through the first resistor; another terminal of the first capacitor is grounded; a terminal of the second capacitor is connected to the emitter of the first transistor; another terminal of the first capacitor is grounded.

13. The audio device of claim 12, wherein the first capacitor and the second capacitor are electrolytic capacitor, and the capacitance of the first capacitor is larger than that of the second capacitor.

14. The audio device of claim 9, wherein the control module comprises a micro control unit (MCU), a second transistor, a third diode; the MCU comprises a first pin; a base of the second transistor is connected to the first pin; an emitter of the second transistor is connected to the power supply; a collector of the second transistor is connected to the delay module through the third diode; an anode of the third diode is connected to the collector of the second transistor; a cathode of the third diode is connected to the delay module.
